(19) United States
(12) Patent Application Publication
(10) Pub. No.: US 2013/0103698 A1
(43) Pub. Date: Apr. 25, 2013

(54) Displaying items in sorted order, and displaying each item in manner corresponding to or based on item's relevance score

(71) Applicant: Carsten Schlipf, Gaeufelden (DE)

(72) Inventor: Carsten Schlipf, Gaeufelden (DE)

(21) Appl. No.: 13/278,183

(22) Filed: Oct. 21, 2011

(51) Int. Cl. G06F 17/30

(52) U.S. Cl. 707/749; 707/E17.058

(57) ABSTRACT

Items are sorted in an order. Each item has a relevance score. The items are displayed in the order in which the items are sorted. Each item is displayed in a manner corresponding to or based on the relevance score of the item.

### BACKGROUND

Modern computing device users are often inundated with information. As one example, network administrators have at their disposal operations management environments in which the administrators can manipulate computing systems have tens of thousands, if not more, of computing resources to ensure the proper running of these systems. Such environments typically log events that are generated by the computing resources, both on a regular basis when the resources are operating correctly, as well as on an as-needed basis when the computing resources are experiencing errors or faults.

### BRIEF DESCRIPTION OF THE DRAWINGS

FIGS. 1A, 1B, and 1C are diagrams of an example log of example events in which the events can be displayed in a given order and in which each event can be displayed corresponding to or based on its relevance.

FIG. 1D is a diagram of an example graphical user interface element that can be employed to vary the threshold governing which events are displayed.

FIG. 2 is a flowchart of an example method for displaying, more generally, items in a given order and in which each item is displayed corresponding to or based on its relevance.

FIG. 3 is a diagram of an example system for displaying items in a given order and in which each item is displayed corresponding to or based on its relevance.

### DETAILED DESCRIPTION

As noted in the background section, modern computing device users are often inundated with information. This makes it difficult for the users to discern the information that is most relevant to them to formulate proper conclusions regarding the information. Existing approaches to present the most relevant information to such users typically focus on displaying information in the order of relevance to the context at hand. For instance, Internet search engines utilize such an approach.

However, these types of approaches are inapplicable particularly in scenarios in which the information has already been sorted in some manner, and in which this sorting order has to be maintained. As one example, as noted in the background section, network administrators have at their disposal operations management environments in which the administrators can manipulate computing systems having large numbers of computing resources. Such environments generally log events that are generated by the computing resources, and present the events to an administrator in the order in which they have been generated. Due to the large number of events that are logged, it can be difficult for the administrator to discern the particular cause of a problem by simply viewing the log.

Nevertheless, for a network administrator to quickly and properly discern the cause of a problem that the administrator has noted in conjunction with a given log event, the chronological order of the events in the log can be important to maintain. Therefore, existing approaches to presenting the most relevant log events to the users that focus on displaying the log events in their order of relevance are inopportune. This is because such existing approaches generally do not maintain the chronological order of the log events, as noted above.

Disclosed herein are techniques that present relevant information to a user that overcome these types of drawbacks. In general, a number of items, such as log events, may be received, where the log events have been sorted in a given order, such as chronologically. Each item has a relevance score denoting its relevance relative to a selected item. The items are displayed in the order in which the items have been sorted, but each item is displayed in a manner corresponding to, or based on, its relevance score. In this way, the relevance of the items is conveyed to a user, while the predetermined order in which the items have been sorted is still maintained.

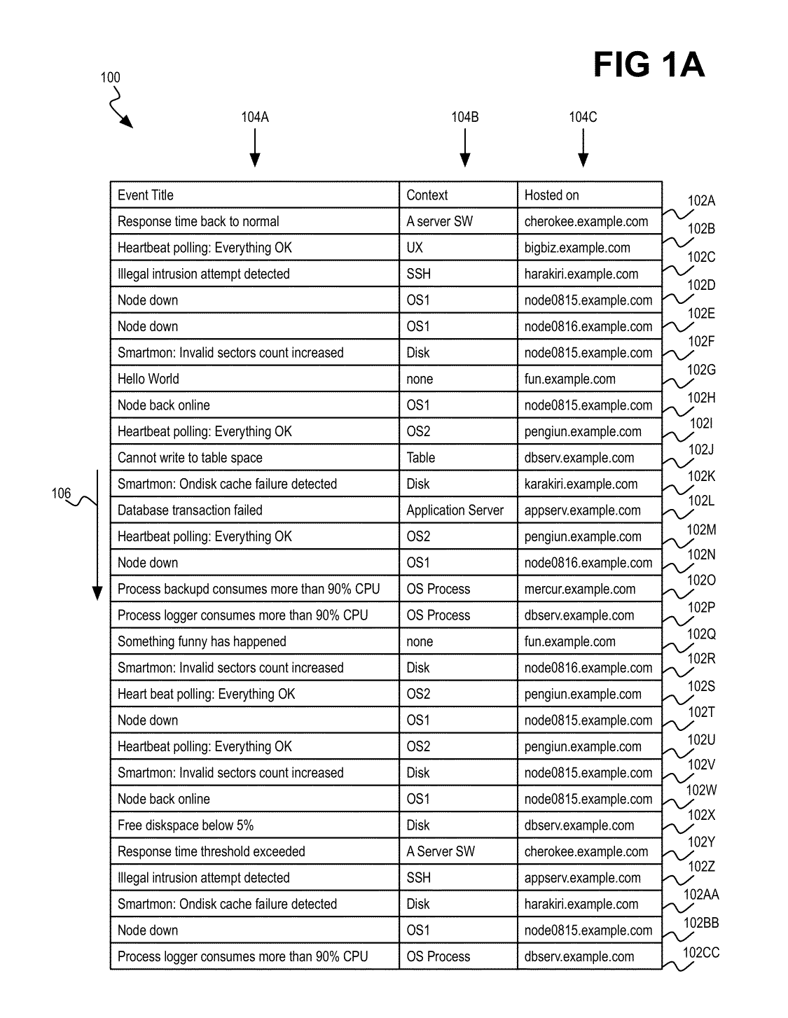

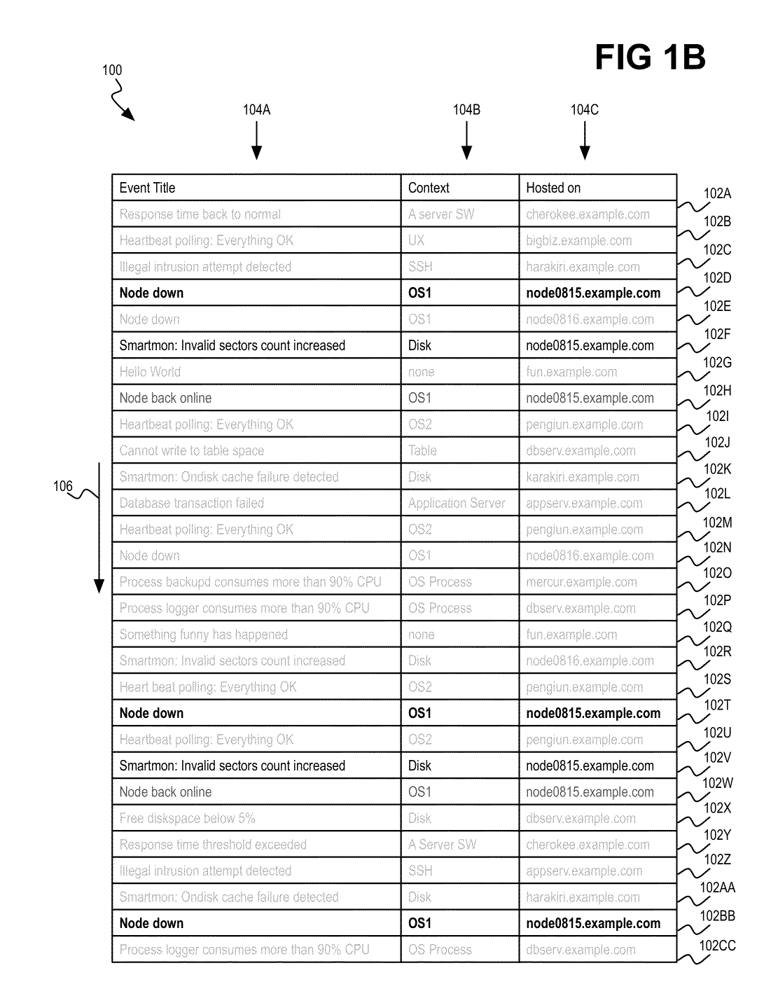

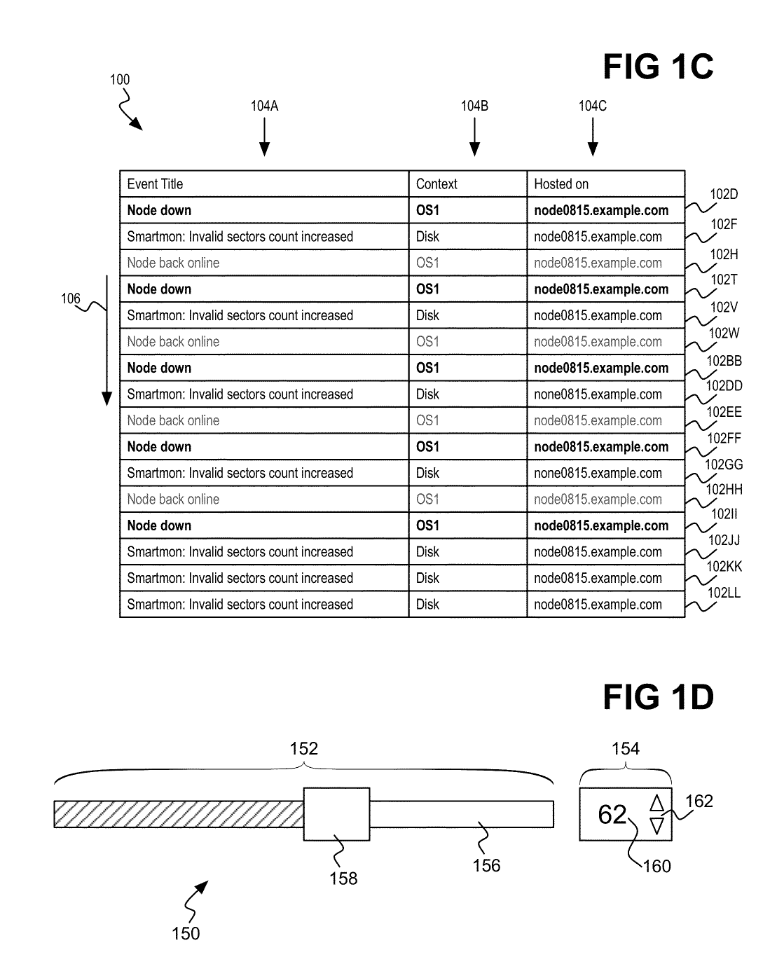

FIGS. 1A, 1B, and 1C illustratively depict an example by which such a novel technique for displaying relevant information while maintaining a predetermined order of this information is explained. FIG. 1A shows an example log 100 of example events 102A, 102B, 102C, 102D, 102E, 102F, 102G, 102H, 102I, 102J, 102K, 102L, 102M, 102N, 1020, 102P, 102Q, 102R, 102S, 102T, 102U, 102V, 102W, 102×, 102Y, 102Z, 102AA, 102BB, and 102CC, which are collectively referred to as the example events 102. The example events 102 may have been generated within an operations management environment in which a number of computing resources, such as hardware as well as software resources, are managed.

The example events 102 have at least three types of information: an event title, a context (such as a configuration item), and a hosted-on address, which are identified by columns 104A, 104B, and 104C, respectively. The columns 104A, 104B, and 104C are collectively referred to as the columns 104. The event title for an event 102 provides a general summary of the event 102 that has occurred. The context for an event 102 indicates the computing resource in relation to which the event 102 has occurred. The hosted-on address for an event 102 indicates the network domain name service (DNS) name of the node at which the computing resource in question is hosted.

The example events 102 are ordered chronologically, as depicted by the arrow 106 in FIG. 1A. As such, the event 102A occurred before the event 102B, the event 102B occurred before the event 102C, and so on. The example events 102 may in this respect also each include a timestamp indicating when the event 102 in question has occurred, but this information is omitted from FIG. 1A for illustrative clarity and convenience.

A user, such as a network administrator, may view the example log 100 on a display device that is part of or that is attached to a computing device, like a desktop or a laptop computer. In reviewing the log 100, the user may note that a computing node hosted at the address node0815.example.com is repeatedly down (i.e., having failed at least temporarily), which log events 102D, 102T, and 102BB denote. However, due to the plethora of information displayed within the log 100, the user may have a difficult time discerning the likely cause for this node going down repeatedly. The user may thus select that the log events 102 are to each be displayed in a manner corresponding to, or base on, its relevance to the log events 102D, 102T, and 102BB.

FIG. 1B shows the example log 100 of the example events 102, in which each event 102 is displayed in a manner corresponding its relevance to the log events 102D, 102T, and 102BB. The events 102 are again displayed with information corresponding to the columns 104. The log events 102D, 102T, and 102BB are most relevant in this respect, and therefore are displayed in a bolded manner with a highest opacity. The log events 102F and 102V have the second highest relevance, and are displayed with a highest opacity but in a non-bolded manner. The log events 102H and 102W have the third highest relevance, and are displayed with slightly less opacity than the log events 102F and 102V are. The other log events 102 have the least relevance, and are therefore displayed with the least opacity.

By the log events 102 being displayed in manners corresponding to or based on their relevance in this way, the user can more easily discern the pattern resulting with the computing node at the address node0815.example.com going down repeatedly. This is because the more relevant events 102 are displayed with greater opacity than less relevant events 102, leading the user's eyes to focus on the more relevant events 102. As such, the user may be able to discern more easily that the computing node in question is going down as a result of a disk problem, insofar as the number of invalid sectors increases each time the node goes down.

Two aspects of the example log 100 of the example events 102 as displayed in FIG. 1B are of further note. First, the example events 102 themselves still remain ordered chronologically, as indicated by the arrow 106. That is, displaying each log event 102 in a manner corresponding to, or based on, its relevance does not affect the overall order in which the events 102 are displayed. Second, in the example of FIG. 1B, all the events 102 that were displayed in FIG. 1A are still displayed in FIG. 1B. That is, none of the log events 102 are hidden in FIG. 1B as compared to as in FIG. 1A. As such, the log 100 is still displayed as completely as possible in FIG. 1B as it was in FIG. 1A.

However, the user may wish to display just the log events 102 that have relevance greater than a particular threshold. This may be achieved for one or more of at least two reasons. First, the user may not care about the log events 102 that have lesser relevance. Second, the display device on which the example log 100 is displayed can just show a limited number of events 102 of the log 100 at any given time due to the size and/or resolution of the display device. Therefore, the user may wish to view more relevant events 102 over a greater time horizon than that which can be displayed if no log events 102 are hidden from view.

FIG. 1C shows the example log 100 of the example events 102, in which the least relevant events 102 have been hidden. Stated another way, just the example events 102 that have relevance greater than a threshold are displayed in FIG. 1C. The events 102 are again displayed with information corresponding to the columns 104. Because the least relevant events 102 are not displayed, more of the more relevant events 102 can be displayed. As such, the example events 102 include events 102DD, 102EE, 102FF, 102GG, 102HH, 102II, 102JJ, 102KK, and 102LL in FIG. 1C. Each of the events 102 displayed in FIG. 1C has a relevance greater than the threshold, and is displayed in a manner corresponding to or based on its relevance, as in FIG. 1B.

By more of the relevant log events 102 being displayed in FIG. 1C as compared to in FIG. 1C, the user can discern that the computing node at the address node0815.example.com has gone down repeatedly for quite some time. The events 102DD through 102LL occurred later than the other events displayed in FIG. 1C, per the chronological order indicated by the arrow 106. The user is more easily able to discern that the pattern with respect to the computing node in question going down is that the node goes down, the number of invalid sectors increases, the node goes back up, and finally the node goes back down again. However, per the events 102JJ, 102KK, and 102LL, it appears that once the node has gone down a final time, it has not gone back up, and the number of invalid sectors has kept increasing.

FIGS. 1A, 1B, and 1C thus provide an example by which the events 102, which may more generally be referred to as items, are displayed in accordance with the order in which they have been sorted, but where each event 102 is displayed in a manner based on or corresponding to its relevance. The order in which the items are sorted is typically independent of the relevance of each item. In the example of FIGS. 1A, 1B, and 1C, for instance, the order is chronological, whereas the relevance of each event 102 pertains to how closely the event 102 is related to the computing node at the address 0185.example.com having failed or otherwise having gone down.

Furthermore, the differing displays of the example log 100 in FIGS. 1B and 1C show different approaches by which the example log events 102 can be displayed. In FIG. 1B, the events 102 that were previously displayed in FIG. 1A are again all displayed, but each event 102 is displayed in a manner corresponding to or based on its relevance. By comparison, in FIG. 1C, just the events 102 that exceed a relevance threshold are displayed, such that the least relevant events 102 of FIG. 1A are not displayed in FIG. 1C, and such that more of the events 102 that are relevant can be displayed in FIG. 1C.

FIG. 1D shows an example graphical user interface element 150 by which the threshold can be adjusted in FIG. 1C. The graphical user interface element 150 in the example of FIG. 1D includes two parts: a part 152 and a part 154. The part 152 includes a bar 156 and a selector 158. The part 154 includes a threshold display area 160 and a set of arrows 162. The threshold is displayed in the threshold display area 160, and the selector 158 is located over the bar 156 in accordance with the threshold.

The threshold can be increased or decreased in three different ways. First, the selector 158 can be selected and moved to the left over the bar 156 to decrease the threshold, and can be selected and moved to the right over the bar 156 to increase the threshold. Second, the up arrow 162 can be selected to increase the threshold, and the down arrow 162 can be selected to decrease the threshold. Third, the display area 160 can be selected and the desired threshold directly entered therein.

The display of the events 102 within the log 100 can vary dynamically in substantially real time (i.e., “on the fly”) in FIG. 1C as the graphical user interface element is manipulated in FIG. 1D. That is, when the threshold is increased, just more relevant of the events 102 are responsively displayed, and when the threshold is decrease, less relevant of the events 102 are also responsively displayed. By sliding the selector 158 over the bar 156, a user thus can in substantially real time cause the events 102 that are displayed within the log 100 in FIG. 1C to dynamically change. This permits a user to see a “bird's eye” view of more events 102 as desired, and also to “drill down” to see just more relevant of the events 102.

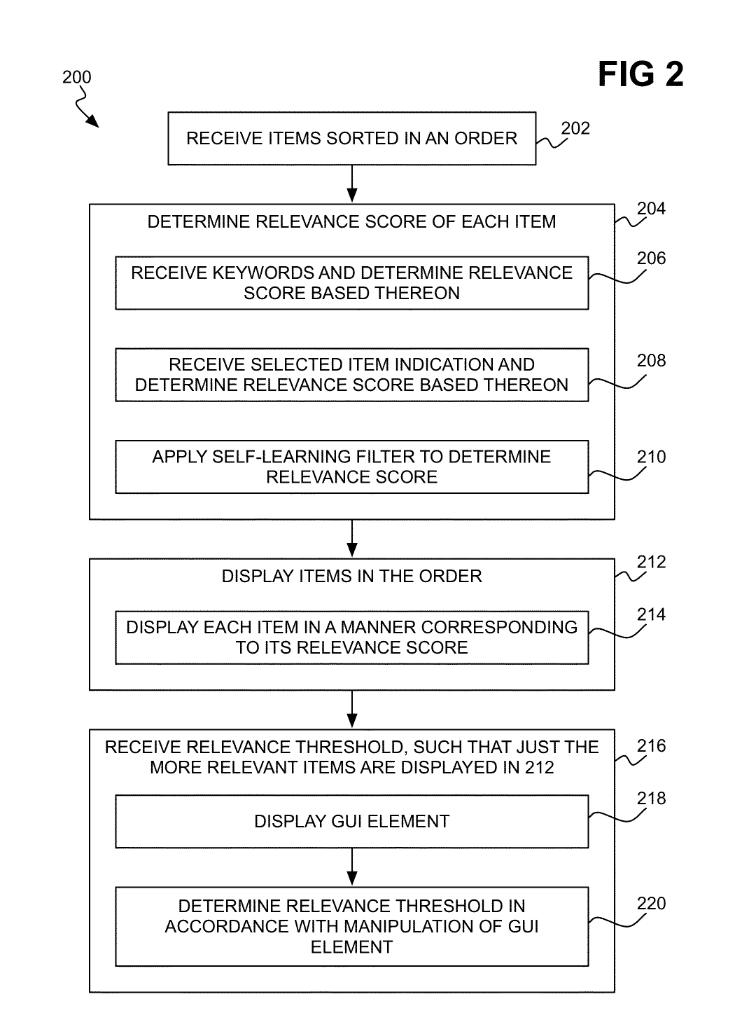

FIG. 2 shows an example method 200 of an overall approach for displaying items that generalizes the particular example of FIGS. 1A, 1B, and 1C. The method 200 is performed by a processor of a computing device, such as a desktop or a laptop computer, which may be a part of an operations management environment. As such, the method 200 can be implemented as one or more computer programs stored on a computer-readable data storage medium. Execution of the computer programs by the processor causes the method 200 to be performed.

A number of items are received (202). The items can include log events, as have been described in relation to FIGS. 1A, 1B, and 1C. The items can be different types of items as well. For instance, the items may be files, such as data files as are commonly stored on computing storage devices and displayed within lists in some order, such as chronologically, alphabetically, and so on. The items may also be email messages, which are also typically displayed within lists in some order. The items may further and more generally be results that are received responsive to performance of a prior operation, and which are sorted in an order; the aforementioned log events are one such type of results.

The items thus are sorted in an order. That is, the items have an order. In the example of FIGS. 1A, 1B, and 1C, the order in question is chronological. However, as noted in the previous paragraph, the order may instead be alphabetical. Other types of order may govern the items as well.

Each item is said to have a relevance score. The relevance score is a numeric or other parameter associated with an item that indicates its relevance to some characteristic relative to one or more items, such as to one or more selected items, to the other items, and so on. In the example of FIGS. 1A, 1B, and 1C, for instance, the relevance score may be a measure of the relevance of each event 202 to the node at the address node0815.example.com having gone down. The relevance scores of the items can be independent of the order in which the items have been sorted. Stated another way, the order in which the items are sorted can be other than by relevance score, as is the case in the example of FIGS. 1A, 1B, and 1C, in which the order is chronological.

The relevance scores may be received along with the items in their order in part 202. The relevance score of each item may, however, be determined (204), particularly where the relevance scores have not been received with the items. As one example, one or more keywords may be received, such as from a user via an appropriate graphical user interface element, and the relevance score of each item determined based on the presence of the keywords within the item (206). For instance, where each item includes textual content, the percentage of the keywords found in the textual content of an item may be the relevance score of the item.

As another example, indication of a selected item, such as by a user via an appropriate graphical user interface element, may be received, and the relevance score of each item determined based on a similarity of the item with the selected item (208). Different algorithmic approaches may be used to determine the similarity between an item and the selected item. The end result is that the relevance score of each item indicates how similar the item is to the item that has been selected.

As a third example, a self-learning filter may be applied to each item to determine the relevance score of the item (210). Examples of self-learning filters include Bayesian filters, for instance, as well as other types of probabilistic filtering approaches, and other types of filtering approaches. The filters may be governed by one or more parameters that dictate how relevance is to be determined, such that application of the filters provides each item with an associate relevance score. Self-learning filters can be useful where the criteria governing relevance are relatively complex.

The items are displayed in the order in which they have been sorted (212). Where there are more items than can be displayed on a display device at a particular time, the items may displayed as a scrollable list of items sorted in their governing order. The user can thus scroll backwards and forwards through the list to view the items of interest.

Furthermore, each item is displayed in a manner corresponding to its relevance score (214). As one example, each item may be displayed at an opacity level corresponding to its relevance score, as in the example of FIGS. 1A, 1B, and 1C. As other examples, each item may be displayed at a font size corresponding to its relevance score, in a color corresponding to its relevance score, and/or with a text style corresponding to its relevance score. In general, items having higher or greater relevance scores are displayed in manners that attract the user's eyes more so than items having lower or less relevance scores.

As noted above in relation to FIG. 1B, in one scenario, all the items that have been received in part 202 are displayed in part 212, regardless of the relevance scores of the items. Rather, in this scenario, the relevance score of an item dictates just how the item is to be displayed, and not whether the item is to be displayed. However, in another scenario, a relevance threshold can be received (216), such that in part 212 just the more relevant items are displayed, and so that less relevant items are not displayed, as noted above in relation to FIG. 1C.

More specifically, the relevance threshold effectively divides the items received in part 202 into two groups: less relevant items, and more relevant items. The less relevant items may have relevance scores less than the relevance threshold, for instance, whereas the more relevance items may have relevance scores greater than the relevance threshold. As such, just the more relevant items are displayed in part 212, and not the less relevant items.

The relevance threshold may be received as follows. A graphical user interface element may be displayed (218). The graphical user interface element is manipulable to set the relevance threshold. For instance, the element may be a slider element that a user can select and move to increase or decrease the relevance threshold. As such, the relevance threshold is determined in accordance with manipulation of the graphical user interface element in question (220).

The display of the items in part 212 may be dynamic, in accordance with the manipulation of the graphical user interface element in part 218. As the user increases or decreases the relevance threshold, that is, the items that were more relevant and that are now less relevant are no longer displayed in part 212, or the items that were less relevant and that are now more relevant are displayed in part 212. In this way, the user receives near instantaneous feedback as to how manipulation of the graphical user interface element affects which items are displayed on the display device.

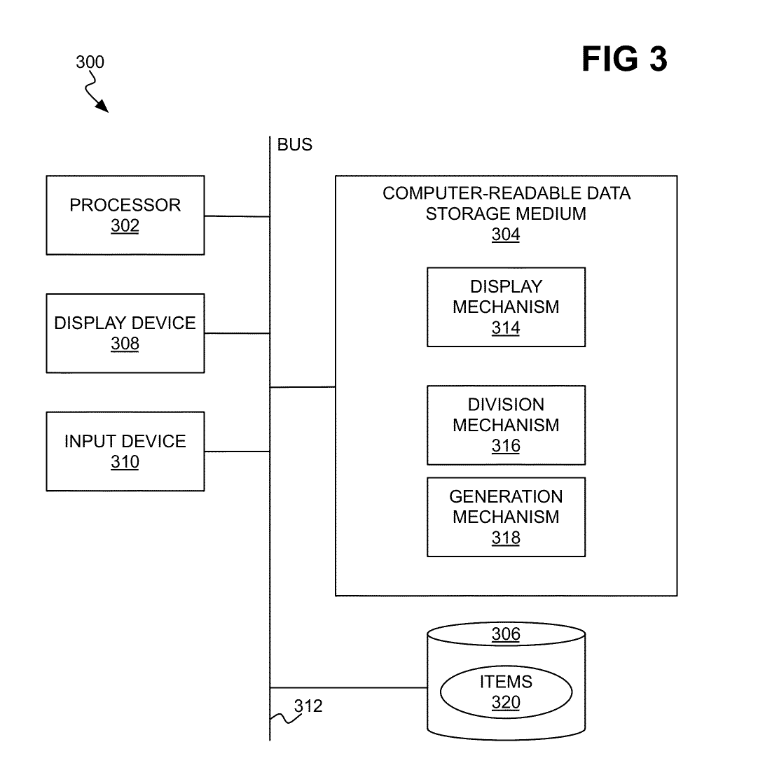

FIG. 3 shows an example system 300. The system 300 can be a computing system, implemented as or over one or more computing devices, such as desktop and laptop computers. The system 300 can include a processor 302, a computer-readable data storage medium 304, a storage device 306, a display device 308, and an input device 310, which are communicatively connected to one another over one or more buses 312.

The computer-readable data storage medium 304 can be a volatile or a non-volatile medium, such as semiconductor memory, magnetic media, and so on. The storage device 306 may be the same or a different computer-readable data storage medium as the medium 304. The display device 308 is a device that displays data, such as a liquid-crystal display (LCD), or another type of display device. The input device 310 can include or be one or more of a keyboard, a pointing device such as a mouse or a touchpad, and so on.

The computer-readable data storage medium 304 includes a display mechanism 314, a division mechanism 316, and a generation mechanism 318, which may each be one or more computer programs, or computer program parts of the same computer program, that are executable by the processor 302. As such, it is said that the mechanisms 314, 316, and 318 are implemented by the processor 302 in this respect. The storage device 306 stores items 320 that are sorted in an order.

The mechanisms 314, 316, and 318 perform the method 200 that has been described, in relation to the items 320. The display mechanism 314 performs the item display-related functionality of parts 212 and 214; the mechanism 314 is a display mechanism in that it displays the items 320. The division mechanism 316 performs the relevance threshold-related functionality of parts 216, 218, and 220; the mechanism 314 is a division mechanism in that it divides the items 320 into less relevant and more relevant items. The generation mechanism 318 performs the relevance score-related functionality of parts 204, 206, 208, and 210; the mechanism 318 is a generation mechanism in that it generates, or determines, the relevance score of each item 320.

The system 300 thus permits a user to discern patterns within items having an order. The system 300 maintains the order of the items when displaying them to the user. However, the system 300 displays each item in a manner corresponding to or based on its relevance. As such, the user is still able to view the items in their order, but is more easily able to discern patterns within the items, due to their being displayed in manners corresponding to or based on their relevance.

We claim:

1. A method comprising:
receiving a plurality of items, by a processor, each item having a relevance score, the items sorted in an order other than by the relevance scores of the items; and,
displaying the items in the order in which the items are sorted, by the processor, including displaying each item in a manner corresponding to the relevance score of the item.

2. The method of claim 1, further comprising:
receiving a relevance threshold, by the processor, such that the items comprise one or more less relevant items that the relevance scores of which are less than the relevance threshold and one or more relevant items that the relevance scores of which are greater than the relevance threshold,
wherein displaying the items comprising displaying just the more relevant items, such that the less relevant items are not displayed.

3. The method of claim 2, wherein receiving the relevance threshold comprises:
displaying a graphical user interface element that is manipulable to set the relevance threshold; and,
determining the relevance threshold in accordance with manipulation of the graphical user interface element.

4. The method of claim 3, wherein displaying the items comprises dynamically displaying in substantially real time just the more relevant items, such that the less relevant items are not displayed, as the graphical user interface element is manipulated and as the relevance threshold is determined in accordance with the manipulation of the graphical user interface element.

5. The method of claim 1, wherein displaying the items comprises displaying all the plurality of items that have been received.

6. The method of claim 1, wherein displaying the items in the order in which the items have been sorted comprises displaying the items in a scrollable list according to the order in which the items have been sorted.

7. The method of claim 1, wherein displaying each item in a manner corresponding to the relevance score of the item comprises one or more of:
displaying each item at an opacity level corresponding to the relevance score of the item;
displaying each item at a font size corresponding to the relevance score of the item;
displaying each item in a color corresponding to the relevance score of the item;
displaying each item with a text style corresponding to the relevance score of the item.

8. The method of claim 1, further comprising:
determining, by the processor, the relevance score of each item.

9. The method of claim 8, wherein determining the relevance score of each item comprises one of:
receiving one or more keywords, and determining the relevance score of each item based on presence of the keywords within the item;
receiving indication of a selected item of the plurality of items, and determining the relevance score of each item based on a similarity between the item and selected item;
applying a self-learning filter to each item to determine the relevance score of each item.

10. The method of claim 1, wherein the items comprise a plurality of log events, each log event generated within an operations management environment.

11. The method of claim 1, wherein the items comprise one of:
a plurality of files;
a plurality of email messages;
a plurality of results received through prior performance of an operation.

12. A computer-readable data storage medium storing a computer program executable by a processor to perform a method comprising:
determining a relevance score of each item of a plurality of items, the items sorted in an order other than by the relevance scores of the items; and,
displaying the items in the order in which the items are sorted, including displaying each item in a manner based on the relevance score of the item.

13. The computer-readable data storage medium of claim 12, wherein the method further comprises:
receiving a relevance threshold, such that the items are divisible into one or more less relevant items that the relevant scores of which are less than the relevance threshold and one or more relevant items that the relevance scores of which are greater than the relevance threshold,
wherein displaying the items comprising displaying just the more relevant items, such that the less relevant items are not displayed.

14. A system comprising:
a processor;
a computer-readable data storage medium to store a plurality of items, each item having a relevance score, the items sorted in an order other than by the relevance scores of the items; and,
a display mechanism implemented at least by the processor to display on a display device the items in the order in which the items are sorted and to display each item in a manner based on the relevance score of the item.

15. The system of claim 14, further comprising:
a division mechanism implemented at least by the processor to divide the items into one or more less relevant items that the relevant scores of which are less than a relevance threshold and one or more relevant items that the relevance scores of which are greater than the relevance threshold,
wherein the display mechanism is to display on the display device just the more relevant items, such that the less relevant items are not displayed on the display device.
